(19) United States
(12) Patent Application Publication
(10) Pub. No.: US 2020/0380713 A1
(43) Pub. Date: Dec. 3, 2020

(54) VEHICLE AND CONTROL METHOD THEREOF

(71) Applicants: Hyundai Motor Company, Seoul (KR); Kia Motors Corporation, Seoul (KR)

(72) Inventors: Jaeseob Choi, Suwon-si (KR); DaeJoong Yoon, Hwaseong-si (KR); JoongRyoul Lee, lncheon (KR); Junhyung Kim, Seoul (KR); Jongho Park, lncheon (KR); Jin Ho Park, Hwaseong-si (KR); KapJe Sung, Yongin-si (KR)

(73) Assignees: Hyundai Motor Company, Seoul (KR); Kia Motors Corporation, Seoul (KR)

(21) Appl. No.: 16/687,429

(22) Filed: Nov. 18, 2019

(30) Foreign Application Priority Data
Jun. 3, 2019 (KR) 10-2019-0065630

(51) Int. Cl. G06T 7/70; B60R 11/04

(52) U.S. Cl. CPC G06T 7/70; B60R 2300/806; G06T 2207/30264; B60R 11/04

(57) ABSTRACT

A vehicle may include an output unit; a camera for obtaining a surrounding image of the vehicle; and a controller configured to: determine a positional relationship between at least one object included in the surrounding image and the vehicle, determine image coordinates based on space information included in the surrounding images, and determine at least one parking area by comparing the space information included in the image coordinates with predetermined size information related to the vehicle in the top view image of the vehicle based on the surrounding image.

### CROSS-REFERENCE TO RELATED APPLICATION(S)

The present application claims priority to Korean Patent Application No. 10-2019-0065630, filed on Jun. 3, 2019, the entire contents of which is incorporated herein for all purposes by this reference.

### BACKGROUND OF THE INVENTION

### Field of the Invention

The present invention relates to a vehicle and a control method for displaying a parking space so that a driver can easily recognize the space.

### Description of Related Art

Surround view (Surround View Monitoring) is a function to generate a top view (top view) screen as if an image of vehicle was taken from the top portion of a navigation screen, using four cameras one by one on front and rear and rear left and right side mirrors.

By use of the Surround View Monitoring system, a driver can grasp the situation around the vehicle at a glance and park safely or pass a narrow road.

On the other hand, recently, a technology of an automatic parking system RSPA (Remote Smart Parking Assist) in which the vehicle is parked autonomously has been developed.

This technology is a technology to search for a space which may be parked in by the vehicle itself, and parking based on the situation of the vehicle.

When the parking space is detected, the technology may be performed by selecting a possible parking type and a position of right angle parking and parallel parking according to the surrounding parking situation.

On the other hand, the above operation occurs when the driver has difficulty parking because there is no guidance about the location. Therefore, studies to deliver accurate parking position information using the above-described Surround view Monitoring (SVM) have been actively conducted.

The information included in this Background of the present invention section is only for enhancement of understanding of the general background of the present invention and may not be taken as an acknowledgement or any form of suggestion that this information forms the prior art already known to a person skilled in the art.

### BRIEF SUMMARY

According to an exemplary embodiment of the present invention, a parking space is displayed in a top view image of a vehicle to provide the vehicle with a control method thereof, which provides accurate parking information to a driver.

Various aspects of the present invention are directed to providing a vehicle includes: an output unit; a camera for obtaining a surrounding image of the vehicle; and a controller configured to: determine a positional relationship between at least one object included in the surrounding image and the vehicle, determine image coordinates based on space information included in the surrounding images, and determine at least one parking area by comparing the space information included in the image coordinates with predetermined size information related to the vehicle in a top view image of the vehicle based on the surrounding image.

The controller may be configured to display the at least one parking area as a first marker and output the top view image to the output unit when at least a portion of the at least one parking area is included in the top view image.

The controller may be configured to output the top view image based on the first marker and output the top view image to the output unit.

The controller may be configured to change the top view image so that the first marker is included in the top view image and output the top view image to the output unit.

The controller may be configured to display a direction corresponding to the at least one parking area as a second marker in the top view image based on the positional relationship between the at least one parking area and the vehicle when the at least one parking area is not included in the top view image.

The controller may be configured to change a shape of the second marker based on a distance between the vehicle and the at least one parking area.

The controller may be configured to remove the at least one parking area included in the top view image when a distance between the vehicle and the at least one parking area is less than a predetermined value.

The controller may be configured to display the at least one parking area determined based on a driving state in the top view image of the vehicle.

In accordance with one aspect of the present invention, a control method of a vehicle includes: obtaining a surrounding image of the vehicle; determining a positional relationship between at least one object included in the surrounding image and the vehicle; determining image coordinates based on space information included in the surrounding image; determining at least one parking area by comparing the space information included in the image coordinates with predetermined size information related to the vehicle; and outputting the at least one parking area to an output unit by marking the at least one parking area in a top view image of the vehicle based on the surrounding image.

The outputting of the at least one parking area to the output unit by marking the at least one parking area may include displaying the at least one parking area as a first marker and outputting the top view image to the output unit when at least a portion of the at least one parking area is included in the top view image.

The control method of the vehicle may further include outputting the top view image based on the first marker and outputting the top view image to the output unit

The control method of the vehicle may further include changing the top view image so that the first marker is included in the top view image and outputting the top view image to the output unit.

The outputting of the at least one parking area to the output unit by marking the at least one parking area may include displaying a direction corresponding to the at least one parking area as a second marker in the top view image based on the positional relationship between the at least one parking area and the vehicle when the at least one parking area is not included in the top view image.

The control method of the vehicle may further include changing a shape of the second marker based on a distance between the vehicle and the at least one parking area.

The control method of the vehicle further including removing the at least one parking area included in the top view image when a distance between the vehicle and the at least one parking area is less than a predetermined value.

The outputting of the at least one parking area to the output unit by marking the at least one parking area may include displaying the at least one parking area determined based on a driving state in the top view image of the vehicle.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

These above and/or other aspects of the present invention will become apparent and more readily appreciated from the following description of exemplary embodiments of the present invention, taken in conjunction with the accompanying drawings in which:

FIG. 1 is a view showing the outside of a vehicle and a camera according to an exemplary embodiment of the present invention.

FIG. 2 is a control block diagram of a vehicle according to an exemplary embodiment of the present invention.

FIG. 3 is a diagram for describing an operation of determining image coordinates according to an exemplary embodiment of the present invention.

FIG. 4A and FIG. 4B are diagrams for describing an operation when a parking area is included in a top view according to an exemplary embodiment of the present invention.

FIG. 5 is a view for explaining an operation when a portion of a parking area is included in a top view according to an exemplary embodiment of the present invention.

FIG. 6 is a view for explaining an operation when a parking area is not included in a top view according to an exemplary embodiment of the present invention.

FIG. 7 is a diagram for describing a parking area determined based on a driving state of a vehicle according to an exemplary embodiment of the present invention.

FIG. 8 is a diagram for describing an operation based on a distance between a vehicle and at least one parking area according to an exemplary embodiment of the present invention.

FIG. 9A and FIG. 9B are diagrams for describing an operation of changing a top view image according to an exemplary embodiment of the present invention.

FIG. 10A and FIG. 10B are diagrams for describing an operation of determining a location and a size of a parking area according to an exemplary embodiment of the present invention.

FIG. 11 is a flowchart according to an exemplary embodiment of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent portions of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Like numbers refer to like elements throughout the present specification and in the drawings. This specification does not describe all components of the embodiments, and general information in the Field of the Invention to which an exemplary embodiment of the present invention belongs or overlapping information between the exemplary embodiments is also not described. The terms “part,” “module,” “element,” and “block,” as used herein, may be implemented as software or hardware, and in the disclosed exemplary embodiments of the present invention, a plurality of “parts,” “modules,” “elements,” and “blocks” may be implemented as a single component, or a single “part,” “module,” “element,” and “block” may include a plurality of components.

It will be understood that when a component is referred to as being “connected” to another component, it may be directly or indirectly connected to the other component. When a component is indirectly connected to another component, it may be connected to the other component through a wireless communication network.

Also, it will be understood that the terms “includes,” “comprises,” “including,” and/or “comprising,” when used in the present specification, specify the presence of a stated component, but do not preclude the presence or addition of one or more other components.

It will be understood that, although the terms first, second, third, etc. may be used herein to describe various components, these components may not be limited by these terms. These terms are only used to distinguish one component from another.

It is to be understood that the singular forms “a,” “an,” and “the” include plural referents unless the context clearly dictates otherwise.

Reference numerals used in operations are provided for convenience of description, without describing the order of the operations. Also, the operations may be executed in an order different from the stated order unless a specific order is definitely specified in the context.

Hereinafter, the operation principle and embodiments of the present invention are described with reference to the accompanying drawings.

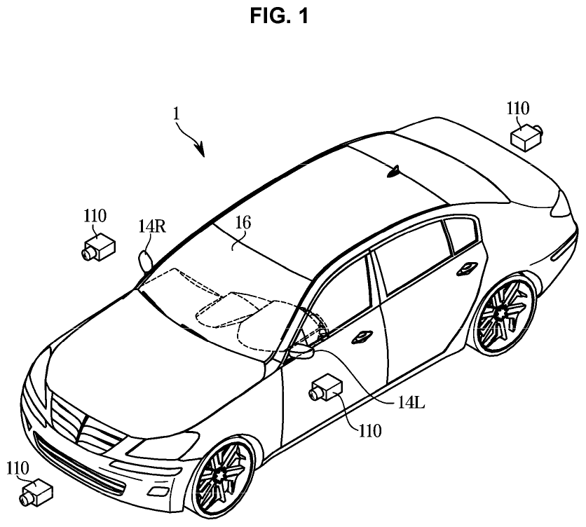

FIG. 1 is a view showing the outside of a vehicle and a camera according to an exemplary embodiment of the present invention.

Referring to FIG. 1, the exterior of a vehicle 1 according to an exemplary embodiment of the present invention may include wheels 12 and 13 for moving the vehicle 1, a doors 15L and 15R for shielding the interior of the vehicle 1 from the outside, a windshield 16 that provides a driver in the vehicle 1 with a view of the front of the vehicle 1, and side mirrors 14L and 14R that provide the driver with a view of the rear of the vehicle 1.

The wheels include the front wheel provided at the front of the vehicle and the rear wheel provided at the rear of the vehicle, and a driving device provide torque to the front or rear wheels, provided inside the vehicle 1 so that the vehicle 1 moves forward or rearward thereof. Such driving device may employ a motor that generates rotational force by receiving power from an engine or a capacitor that burns fossil fuel.

The door is rotatably provided on the left and right sides of the vehicle 1 to allow the driver or passengers to board the interior of the vehicle 1 at the time of opening, and to close the interior of the vehicle 1 from the outside thereof when the door is closed. Furthermore, a handle may be provided outside the vehicle 1 to open or close the doors 15L and 15R, and the handle may be provided with an LF antenna configured for transmitting a low frequency (LF) signal.

Furthermore, the side mirrors 14L and 14R include the left side mirror 14L provided on the left side of the vehicle 1 and the right side mirror 14R provided on the right side thereof. The vehicle 1 makes it possible to obtain visual information on the side and rear of the vehicle 1.

Furthermore, the vehicle 1 may include a sensing device such as a proximity sensor for detecting obstacles or other vehicles at the rear or on the side and a rain sensor for detecting precipitation.

The proximity sensor may transmit a detection signal to the side or the rear of the vehicle, and receive a reflection signal reflected from an obstacle such as another vehicle.

On the basis of a waveform of the received reflection signal to detect the presence of an obstacle on the side or at the rear of the vehicle 1, it is possible to detect the position of the obstacle.

As an example of such proximity sensor, a method of transmitting ultrasonic waves or infrared rays and detecting a distance to the obstacles by use of the ultrasonic waves or the infrared rays reflected on the obstacles may be adopted.

Furthermore, the vehicle may include an image obtaining unit 110 including cameras 110-1, 110-2, 110-3, and 110-4.

The cameras 110-1, 110-2, 110-3, and 110-4 forming the image obtaining unit 110 and obtaining the surrounding image of the vehicle is provided at the front, rear and side of the vehicle to obtain an image.

Images acquired by each of the cameras 110-1, 110-2, 110-3, and 110-4 may be derived as vehicle surrounding images through a method described below.

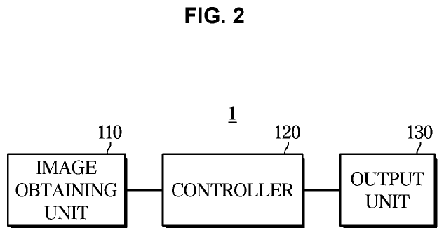

FIG. 2 is a control block diagram of a vehicle according to an exemplary embodiment of the present invention.

Referring to FIG. 2, the vehicle 1 according to an exemplary embodiment of the present invention may include the image obtaining unit 110, an output unit 130, and a controller 120.

The image obtaining unit 110 may acquire the surrounding image. The configuration of the image obtaining unit 110 is as described above.

The output unit 130 may output a top view image, a parking area, a marker, and the like, derived on the basis of an operation to be described later.

The output unit 130 may be a Cathode Ray Tube (CRT), Digital Light Processing (DLP) panel, Plasma Display Panel (PDP), Liquid Crystal Display (LCD) panel, Electro Luminescence (EL) panel, Electrophoretic Display (EPD) panel, Electrochromic Display (ECD) panel, Light Emitting Diode (LED) panel, or Organic Light Emitting Diode (OLED) panel, etc., but is not limited thereto.

The controller 120 may determine image coordinates based on a positional relationship between at least one object included in the surrounding image and the vehicle 1 and spatial information included in the surrounding image.

In detail, the controller 120 may receive a parking space position and convert the parking space position into the image coordinates.

Furthermore, the controller 120 may determine at least one parking area by comparing a space area included in the image coordinates with size information related to the predetermined vehicle 1.

That is, the controller 120 determines that the derived space area is greater than the predetermined size of the vehicle 1 and determines that the parking area is available, and determines the space area as the parking area.

Furthermore, the controller 120 displays the at least one parking area in the top view image of the vehicle 1 derived based on the surrounding image acquired by the image obtaining unit 110 from the output unit 130.

The top view image of the vehicle 1 is a front image, rear image, left image and right image obtained from four of the image obtaining units 110 respectively included on the front, both side mirrors, trunk, etc. of the vehicle 1. The image may be converted into one top view image having a viewpoint viewed from the top portion of the vehicle 1.

The vehicle 1 may use an image registration processing technique for converting different front images, rear images, left images, and right images into one top view image.

The display quality of the top view image may be determined by the conformity according to an image matching processing technique.

When at least a portion of the at least one parking area is included in the top view image, the controller 120 may display the at least one parking area as a first marker and control the output of the top view image to the output unit 130.

The first marker is a mark which is distinguished from a second marker to be described later and is not limited in form.

The controller 120 may output the top view image based on the first marker to the output unit 130.

The controller 120 may be formed based on a reference point in forming the top view image.

The top view image is formed based on the position of the vehicle 1, but when the parking area is included in the top view image, the parking area is determined as a reference point so that the parking area is included in the top view image, and the top view image may be formed.

The controller 120 may control the first marker to be output to the output unit 130 by changing the top view image to include the first marker in the top view image.

That is, in forming the top view image based on the vehicle 1, the parking area may not be included in the top view image in the parking progress of the vehicle 1.

In the instant case, the top view image may be changed such that the parking area is included in the top view image by changing a magnification of the top view image.

Based on the positional relationship between the at least one parking area and the vehicle 1, a direction corresponding to the at least one parking area may be displayed in the top view image as the second marker and controlled to be output to the output unit 130 when the controller 120 does not include the at least one parking area in the top view image.

The second marker may be displayed differently from the above-described first marker, and the direction or the shape may be changed based on the positional relationship.

That is, the controller 120 may change the shape of the second marker based on the distance between the vehicle 1 and the at least one parking area.

When the distance between the vehicle 1 and the at least one parking area is less than a predetermined value, the controller 120 may remove the at least one parking area included in the top view image.

When the vehicle 1 approaches the parking area, there is no need to mark the parking area anymore.

The controller 120 may remove the at least one parking area from the top view image when the vehicle 1 approaches the parking area.

The controller 120 may display one of the parking areas determined based on a driving state of the vehicle 1 in the top view image of the vehicle 1.

The controller 120 may determine the parking position of the vehicle 1 based on the driving state of the vehicle 1.

When the plurality of parking areas are determined, the controller 120 may display only the parking area in which the parking is expected, corresponding to the corresponding parking location, in the top view image.

The controller 120 includes a memory for storing data for a program reproducing an algorithm or an algorithm for controlling the operation of components in the vehicle, and a processor for performing the above-described operation using the data stored in the memory. At the instant time, the memory and the processor may be implemented as separate chips. Alternatively, the memory and the processor may be implemented in a single chip.

At least one component may be added or deleted corresponding to the performance of the components of the vehicle shown in FIG. 2.

It will be readily understood by those skilled in the art that the mutual position of the components may be changed corresponding to the performance or structure of the system.

In the meantime, each of the components shown in FIG. 2 denotes a hardware component such as software and/or a Field Programmable Gate Array (FPGA) and an Application Specific Integrated Circuit (ASIC).

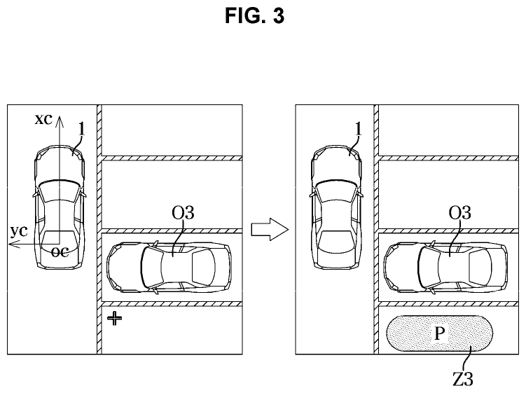

FIG. 3 is a diagram for describing an operation of determining image coordinates according to an exemplary embodiment of the present invention.

Referring to FIG. 3, the vehicle 1 may determine the image coordinates of a rear axle center oc of the vehicle 1 as an origin during autonomous driving. The vehicle 1 may display the parking area in the direction of the parking space at the position of a right parking area position coordinate and a left parking area position coordinate.

In detail, the controller 120 may receive a parking area Z3 position and convert the parking area Z3 position into the image coordinates. The controller 120 may determine whether the corresponding space area is an area where the vehicle 1 can park using the space area and the size information related to the vehicle 1 based on the acquired image.

The controller 120 may display the parking area Z3 in the derived top view image.

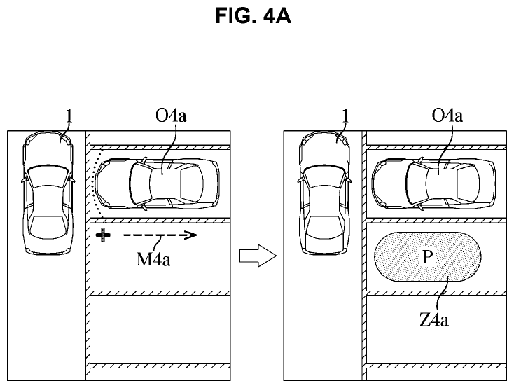

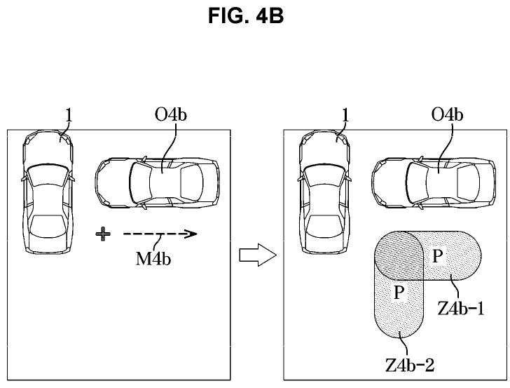

FIG. 4A and FIG. 4B are diagrams for describing an operation when a parking area is included in a top view according to an exemplary embodiment of the present invention.

Referring to FIG. 4A, when a parking line exists, FIG. 4A shows that the vehicle 1 searches for a parking area M4a and the controller 120 determines a parking area Z4a and displays it in the top view image.

In determining the parking area, the location and occupancy information related to a surrounding vehicle O4a may be used.

On the other hand, when a parking line does not exist, FIG. 4B shows that the vehicle 1 can search in a parking area M4b and determine the parking area.

However, at the present time, the vehicle 1 may determine area Z4b-1 as the parking area or the vehicle 1 may determine area Z4b-2 as the parking area.

When the vehicle 1 does not have a parking line, the vehicle 1 may freely park the parking line.

The controller 120 may determine and display a plurality of parking areas. In the instant case, when the parking areas overlap, the controller 120 may display the parking areas by overlapping them.

This operation may also use the location and occupancy information related to a surrounding vehicle O4b. Meanwhile, as shown in FIG. 4A and FIG. 4B, when the entire parking area is included in the top view image, the parking area may be displayed as the first marker.

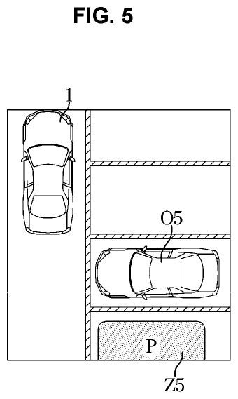

FIG. 5 is a view for explaining an operation when a portion of a parking area is included in a top view according to an exemplary embodiment of the present invention.

Referring to FIG. 5, a case in which a portion of the derived parking area is not included in the top view image is included.

The controller 120 may display a portion Z5 of the derived parking area in the top view image.

That is, even if a portion of the parking area determined by the controller 120 is included in the top view image, only a portion of the parking area may be displayed as the first marker.

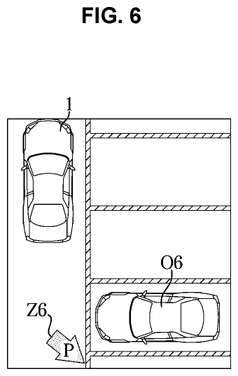

FIG. 6 is a view for explaining an operation when a parking area is not included in a top view according to an exemplary embodiment of the present invention.

Referring to FIG. 6, the parking area is not located in the top view image.

FIG. 6 shows that the vehicle 1 is out of view of the top view of the parking area itself.

In the instant case, the controller 120 may display a direction corresponding to the parking area based on the positional relationship between the vehicle 1 and a parking area Z6.

The controller 120 may display a direction corresponding to the parking area as the second marker distinguished from the first marker.

Furthermore, the second marker may be changed according to the positional relationship between the vehicle 1 and the parking area.

For example, if the distance between the parking area and the vehicle 1 is short, the controller 120 may greatly change the size of the second marker.

According to another exemplary embodiment of the present invention, when the distance between the parking area and the vehicle 1 approaches, the controller 120 may change a color of the second marker to become darker.

Furthermore, the controller 120 may display information on the positional relationship between the parking area and the vehicle 1 on the second marker.

For example, when the distance between the vehicle 1 and the parking area corresponds to 5 meters, the controller 120 may output distance information such as “5M” to the second marker.

On the other hand, the operation described in FIGS. 4A, 4B, 5 and 6 is only an exemplary embodiment for explaining the operation of the present invention and the shape of each of the markers is to output information related to the parking area. There is no limitation of the operation.

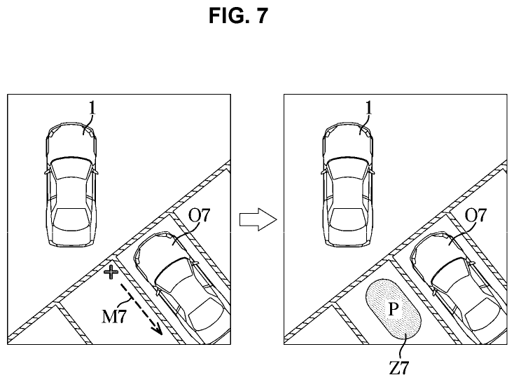

FIG. 7 is a diagram for describing a parking area determined based on a driving state of a vehicle according to an exemplary embodiment of the present invention.

Referring to FIG. 7, the controller 120 may determine a plurality of parking areas in which the vehicle 1 may be parked.

In FIG. 7, an area located in each parking line may be determined as the parking area.

The controller 120 may determine one of the plurality of parking areas as the driving state of the vehicle 1.

In FIG. 7, the vehicle 1 is controlled to travel in an M7 direction thereof. Accordingly, the controller 120 may determine Z7 as the parking area based on the driving state in which the vehicle 1 travels in the M7 direction thereof.

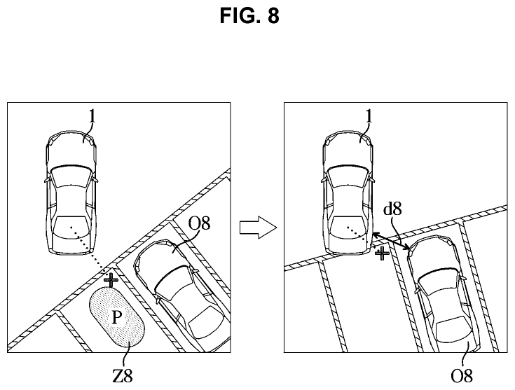

FIG. 8 is a diagram for describing an operation based on a distance between a vehicle and at least one parking area according to an exemplary embodiment of the present invention.

Referring to FIG. 8, if the distance between the vehicle 1 and the at least one parking area is less than a predetermined value, the controller 120 may remove the at least one parking area included in the top view image.

When the vehicle 1 parks in parking area Z8, the controller 120 may display the parking area Z8.

When the vehicle 1 is parking, the controller 120 may determine a distance d8 between the vehicle 1 and the parking area.

If the distance d8 between the vehicle 1 and the parking area is less than the predetermined distance, the parking area Z8 output in the top view image may be removed.

The controller 120 does not need to output the parking area any further when the area in which the vehicle 1 is to be parked close to the parking area is determined.

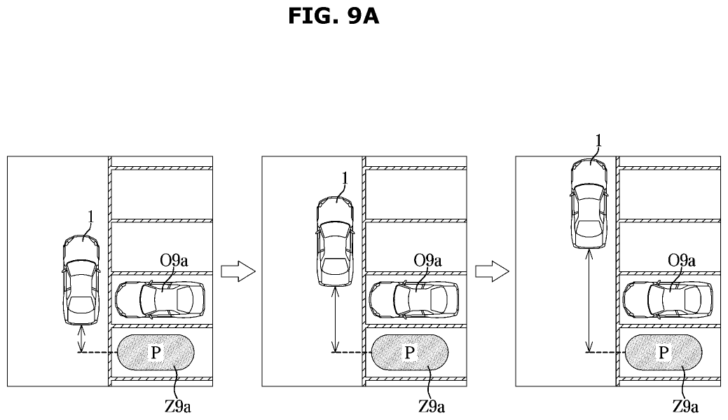

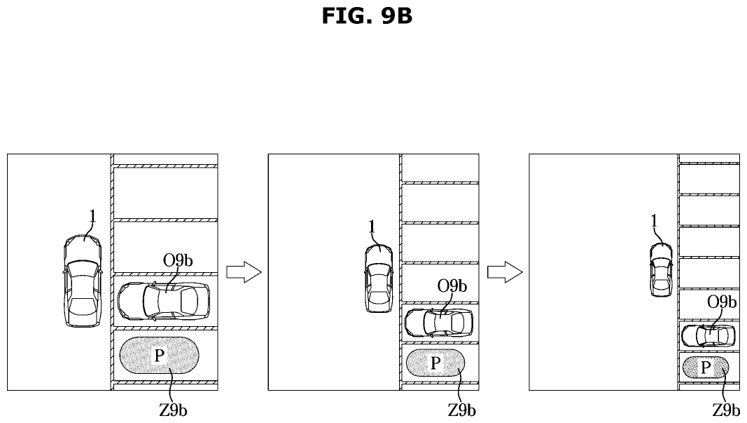

FIG. 9A and FIG. 9B are diagrams for describing an operation of changing a top view image according to an exemplary embodiment of the present invention.

Referring to FIG. 9A, the controller 120 determines a parking area Z9a and displays it in the top view image.

In the instant case, the controller 120 may output the top view image based on the first marker corresponding to the parking area Z9a and outputs the same to the output unit 130.

In FIG. 9A, a parking area Z9 is included in the top view image, and shows that the vehicle 1 is moving.

The controller 120 may control the parking area Z9a to always be included in the top view image by outputting the top view image based on the parking area Z9a even when the vehicle 1 is moving.

The controller 120 may move the area of the top view image by the distance of the parking area.

The controller 120 derives the top view image so that the parking area Z9 is included in the top view image, and controls the parking area Z9 to be included in the top view image despite the movement of the vehicle 1.

Referring to FIG. 9B, the top view image may be changed and output to the output unit 130 such that the first marker corresponding to the parking area is included in the top view image.

FIG. 9B shows that a parking area Z9b is included in the top view image by reducing the top view image.

The controller 120 determines the parking area Z9b and displays it in the top view image.

In the instant case, the controller 120 may enlarge the area of the top view image to include the first marker corresponding to the parking area Z9b.

Meanwhile, FIG. 9B illustrates an operation of changing the area of the top view image. However, if the parking area is an operation included in the top view, the operation of changing the top view image is not limited.

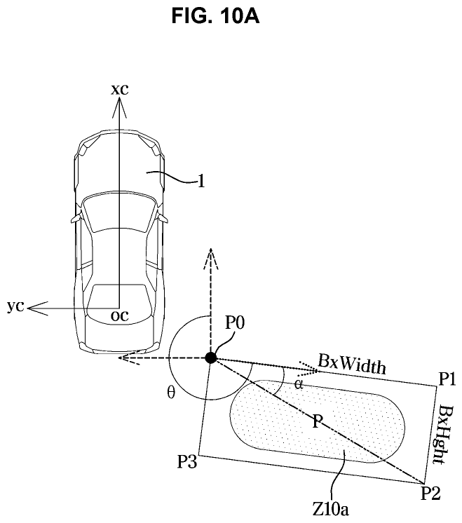

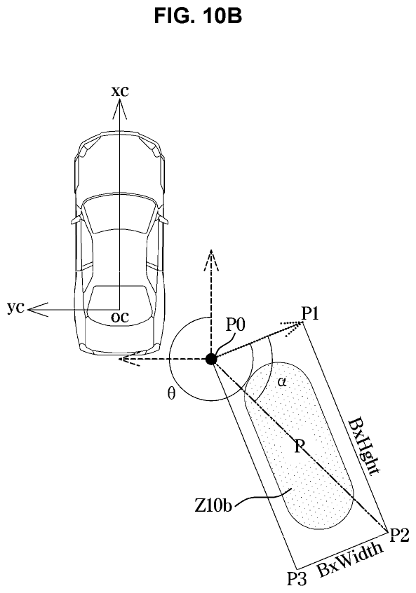

FIG. 10A and FIG. 10B are diagrams for describing an operation of determining a location and a size of a parking area according to an exemplary embodiment of the present invention.

As shown in FIG. 10A and FIG. 10B, P0 denotes a reference point of the vehicle 1.

A length from P0 to P1 refers to a horizontal area BxWidth of the parking area.

A length from P0 to P3 may refer to a vertical area BxHight of the parking area.

Meanwhile, when the coordinate of the vehicle 1 is determined as (−Y0, X0), P1 may be determined by Equation 1.

θ may refer to an angle of the horizontal area BxWidth of the parking area based on an xc axis.

P1=(−Y0−Bxwidth·sin(θ)X0−Bxwidth·(−cos(θ))) [Equation 1]

P2 may be determined by Equation 2.

P2=(−Y0−\sqrt{Bxwidth²+BxHight²}·sin(θ−α),X0−\sqrt{Bxwidth²+BxHight²}·(−cos(θ−α))) [Equation 2]

In Equation 2, a may be determined as a ratio α=arctan (BxWidth/BxHight) of the horizontal area of the parking area and the vertical area of the parking area.

P3 may be determined by Equation 3.

P3=(−Y0−Bxwidth·sin(θ−90°),X0−Bxwidth·(−cos(θ−90°))) [Equation 3]

The controller may be configured to determine the parking area based on the values of P1, P2, and P3 determined based on the above-described operation and the determined P0 point.

The controller can also determine the width of the parking area.

As shown in FIG. 10A and FIG. 10B, a right rectangular parking area Z10a and a right parallel parking area Z10b are illustrated, but a person skilled in the art may derive information on the left parking area based on this.

Meanwhile, the operation of determining the parking area shown in FIG. 10A and FIG. 10B is merely an exemplary embodiment of the present invention, and the operation of determining the location and size of the parking area is not limited.

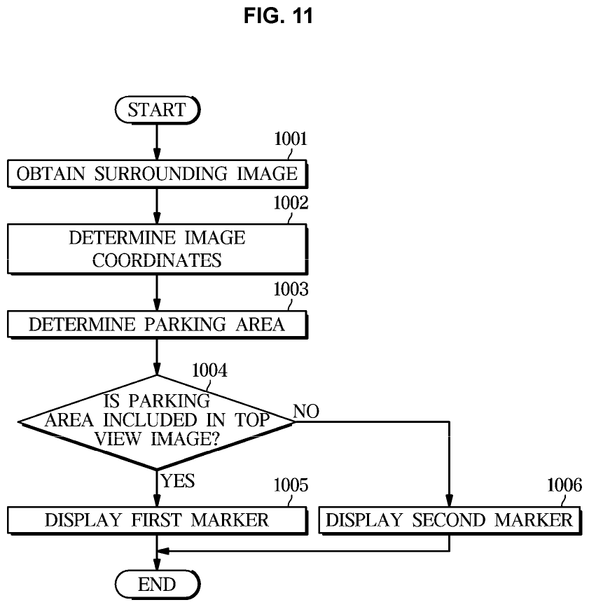

FIG. 11 is a flowchart according to an exemplary embodiment of the present invention.

Referring to FIG. 11, the vehicle may obtain the surrounding image (1001) and determine the image coordinates (1002) based on this.

The vehicle may determine at least one parking area by comparing the space area included in the image coordinates with predetermined size information related to the vehicle (1003).

When the parking area is included in the top view image (1004), the vehicle may display the parking area in the top view image as the first marker (1005). On the other hand, if the parking area is not included in the top view image (1004), the vehicle may display the parking area in the top view image in correspondence with the second marker (1006).

Meanwhile, the exemplary embodiments as described above may be embodied in a form of a recording medium to store commands which may be executed by a computer. The commands may be stored in a form of program codes, and can generate a program module, when executed by the processor, to perform the operations of the above-described embodiments. The recording medium may be embodied as a computer-readable recording medium.

The computer-readable recording medium may be or include any kind of recording device to store commands which may be interpreted by a computer. For example, the computer-readable recording medium may be ROM, RAM, a magnetic tape, a magnetic disk, flash memory, or an optical data storage device.

For the vehicle and the control method thereof according to the exemplary embodiments of the present invention, by recognizing the driving situation of the vehicle upon autonomous driving, and controlling the components of the vehicle when a dangerous situation is detected, safe autonomous driving is possible.

Although Various embodiments of the present invention have been shown and described herein, it may be appreciated by those having ordinary skill in the art that changes may be made in the disclosed exemplary embodiments without departing from the principles and spirit of the present invention, the scope of which is defined in the claims and their equivalents.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A vehicle comprising:
an output unit;
a camera for obtaining a surrounding image of the vehicle; and
a controller connected to the output unit and the camera and configured to:
determine a positional relationship between at least an object included in the surrounding image and the vehicle,
determine image coordinates based on space information included in the surrounding image, and
determine at least a parking area by comparing the space information included in the image coordinates with predetermined size information related to the vehicle in a top view image of the vehicle based on the surrounding image.

2. The vehicle of claim 1, wherein the controller is configured to display the at least a parking area as a first marker and output the top view image to the output unit, upon determining that at least a portion of the at least a parking area is included in the top view image.

3. The vehicle of claim 2, wherein the controller is configured to output the top view image based on the first marker and output the top view image to the output unit.

4. The vehicle of claim 2, wherein the controller is configured to change the top view image so that the first marker is included in the top view image and output the top view image to the output unit.

5. The vehicle of claim 1, wherein the controller is configured to display a direction corresponding to the at least a parking area as a second marker in the top view image based on the positional relationship between the at least a parking area and the vehicle, upon determining that the at least a parking area is not included in the top view image.

6. The vehicle of claim 5, wherein the controller is configured to change a shape of the second marker based on a distance between the vehicle and the at least a parking area.

7. The vehicle of claim 1, wherein the controller is configured to remove the at least a parking area included in the top view image, upon determining that a distance between the vehicle and the at least a parking area is less than a predetermined value.

8. The vehicle of claim 1, wherein the controller is configured to display the at least a parking area determined based on a driving state in the top view image of the vehicle.

9. A control method of a vehicle, the control method including:
obtaining a surrounding image of the vehicle;
determining, by a controller, a positional relationship between at least an object included in the surrounding image and the vehicle;
determining, by the controller, image coordinates based on space information included in the surrounding image;
determining, by the controller, at least a parking area by comparing the space information included in the image coordinates with predetermined size information related to the vehicle; and
outputting, by the controller, the at least a parking area to an output unit connected to the controller, by marking the at least a parking area in a top view image of the vehicle based on the surrounding image.

10. The control method of the vehicle according to claim 9,
wherein the outputting of the at least a parking area to the output unit by marking the at least a parking area includes displaying the at least a parking area as a first marker and outputting the top view image to the output unit, upon determining that at least a portion of the at least a parking area is included in the top view image.

11. The control method of the vehicle according to claim 10, further including outputting the top view image based on the first marker to the output unit.

12. The control method of the vehicle according to claim 10, further including changing the top view image so that the first marker is included in the top view image and outputting the top view image to the output unit.

13. The control method of the vehicle according to claim 9,
wherein the outputting of the at least a parking area to the output unit by marking the at least a parking area includes displaying a direction corresponding to the at least a parking area as a second marker in the top view image based on the positional relationship between the at least a parking area and the vehicle, upon determining that the at least a parking area is not included in the top view image.

14. The control method of the vehicle according to claim 13, further including changing a shape of the second marker based on a distance between the vehicle and the at least a parking area.

15. The control method of the vehicle according to claim 9, further including removing the at least a parking area included in the top view image, upon determining that a distance between the vehicle and the at least a parking area is less than a predetermined value.

16. The control method of the vehicle according to claim 9,
wherein the outputting of the at least a parking area to the output unit by marking the at least a parking area includes displaying the at least a parking area determined based on a driving state in the top view image of the vehicle.
